(19) United States
(12) Patent Application Publication
(10) Pub. No.: US 2003/0211842 A1
(43) Pub. Date: Nov. 13, 2003

(54) Securing binding update using address based keys

(76) Inventors: James Kempf, Mountain View, CA (US); Craig B. Gentry, Mountain View, CA (US); Alice Silverberg, Columbus, OH (US); Anand Desai, Menlo Park, CA (US); Satomi Okazaki, Palo Alto, CA (US); Yiqun Lisa Yin, Old Greenwich, CT (US)

Correspondence Address: BRINKS HOFER GILSON & LIONE, P.O. BOX 10395, CHICAGO, IL, 60611, US

(21) Appl. No.: 10/364,289

(22) Filed: Feb. 11, 2003

Related U.S. Application Data
(60) Provisional application No. 60/358,177, filed on Feb. 19, 2002.
(60) Provisional application No. 60/416,029, filed on Oct. 3, 2002.

(51) Int. Cl. H04M 1/66; H04M 3/16

(52) U.S. Cl. 455/411; 455/410

(57) ABSTRACT

A system and method are disclosed for securing binding updates in a wireless telecommunications system. A public key is generating using a home address value of the mobile host. Thereafter, a home agent, such as a router, generates a private key using public cryptographic parameters, that corresponds to the mobile host and the public key. The correspondent node uses the public key to encrypt a shared key and sends the shared key to the mobile host. The mobile host decrypts the shared key using the private key and uses the shared key to sign the binding update. Thereafter, the correspondent node utilizes the shared key to verify the authenticity of the binding update.

### RELATED APPLICATIONS

This application claims priority to the earlier filed provisional U.S. patent applications Ser. No. 60/358,177, filed Feb. 19, 2002 and Ser. No. 60/416,029, filed Oct. 3, 2002, both entitled “Securing MIPV6 Binding Update Using Address Based Keys (ABK),” which are incorporated by reference herein.

### BACKGROUND

The results of known Mobile IP design work and technical discussions trend toward accepting Return Routability (RR) as the basic technique for securing MIPv6 Binding Update (BU). A wide variety of proposed mechanisms for Return Routability exist. Yet, there is recognition that Return Routability has drawbacks, both in terms of its security properties and also performance.

While identity based cryptosystems are known in the cryptographic community, they have not been used in the networking security community. The Diffie-Hellman technique remains the reigning standard. Moreover, until recently, there have been no known identity based cryptographic algorithms that could be used to perform encryption. The existing algorithms have been restricted to digital signature calculation, and therefore have been limited in scope. Recent work has established new algorithms, based on elliptic curves, which allow encryption to be performed as well.

### BRIEF SUMMARY

A system and method are disclosed for securing Binding Update in a wireless telecommunications system. A public key is established using a home address value of the mobile host. Thereafter, a home agent generates a private key using public cryptographic parameters, that corresponds to the mobile host and the public key.

When the mobile host initiates a conversation with a correspondent node, the mobile host sends a message via the home agent to the correspondent node requesting that the correspondent node obtain the public cryptographic parameters from the home agent. If the correspondent node does not have the cryptographic parameters, the correspondent node obtains the parameters from the home agent. The correspondent node uses the mobile host's home address and the cryptoparameters to encrypt a shared secret key which is sent to the mobile host via the home agent. The mobile host decrypts the shared secret using the private key, and uses the shared secret to calculate a message authentication code on the Binding Update. The correspondent node authenticates the binding update by examining the message authentication code, using the shared secret key.

### BRIEF DESCRIPTION OF THE DRAWINGS

FIG. 1 illustrates an exemplary wireless, mobile access, Internet Protocol network.

FIG. 2 is a ladder diagram illustrating the use of an Identity-based cryptosystem to secure a Binding Update.

FIG. 3 illustrates an exemplary ABK Request message.

FIG. 4 illustrates an exemplary ABK Reply message.

FIG. 5 illustrates an exemplary ABKp1 message.

FIG. 6 illustrates an exemplary ABKp2 message.

FIG. 7 illustrates an exemplary ABKp3 message.

FIG. 8 illustrates an exemplary ABKp4 message.

### DETAILED DESCRIPTION

Presently preferred embodiments of a mechanism for securing telecommunication Binding Update are described herein with reference to the drawings, wherein like components are identified with the same references. The security mechanism includes the use of Address Based Keys (ABKs) or other encryption methodsfrom the Weil paring and cryptosystems based on pairing for shared secret encryption. The descriptions contained herein are intended to be exemplary in nature and are not intended to limit the scope of the invention.

A system and method are described for securing MIPV6 Binding Updates using identity-based cryptography. Identity-based cryptography includes a body of cryptographic techniques that allow a client to use a public identifier, such as its IP address, as its public key. The client obtains private keys, along with a set of public cryptoparameters, from an Identity-based Private Key Generator (IPKG). A correspondent wanting to encrypt a message uses the client's public identity along with the public cryptoparameters. The correspondent obtains the public cryptoparameters from the IPKG. The client decrypts the message using its private key.

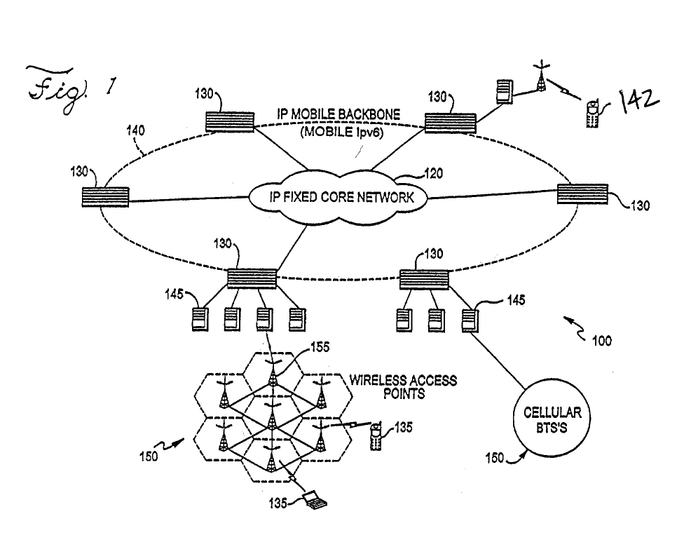

FIG. 1 illustrates an exemplary wireless, mobile access, Internet Protocol (IP) network 100. The wireless, mobile access, IP network 100 has a fixed node IP data network 120 comprising numerous fixed nodes (not shown), i.e., fixed points of connection or links. Data is communicated within and over the network in accordance with Internet protocols such as Internet protocol version 6, specified as IETF RFC 2460, which is incorporated herein by reference. Built on the core network 120 is a collection of gate routers 130 which collectively form an IP mobile backbone 140 and function, in accordance with the conventional Internet addressing and routing protocols, to route packets of data between source and destination nodes connected to the network. The gate routers 130 forming the IP mobile backbone 140 are themselves nodes of the core network 120 and have unique IP addresses for communication over the core network 120.

Connected to each of the gate routers 130 are servers or routers 145, which also have unique IP addresses and function as Home Agents (HA) to interface mobile hosts, such as Mobile Nodes 135, and Correspondent Nodes 142 to the core network 120. The Mobile Node 135 includes an interface to communicate with the Correspondent node 142, and vice versa. The Correspondent Node 142 may also be mobile. The Mobile Node 135 and Correspondent Node 142 may include different kinds of mobile, wireless communication devices including cellular handsets, cellular telephones, hand-held computers, personal information managers, wireless data terminals, and the like.

The Mobile Node 135 has an established security association with one or more home agents 145 on a home link. The Mobile Node 135 is programmed to detect moves between different points of attachment in the network 100. The Mobile Node 135 can be identified by a Home Address (HoA), i.e., an address of the Mobile Node 135 which does not change as the mobile node moves through the network 100. The Mobile Node 135 acquires a temporary care of address (COA) in each visited location of the network 100. The Mobile Node 135 signals a change in care of address to the home agent 145 by sending a Binding Update message, secured by using an IPsec security association.

The agents 145 have a wireless access network 150 by way of which the Mobile Node 135 and Correspondent Nodes 142 communicate with the Home and Foreign Agents 145. The home agent (HA) 145 can be implemented with a router on the home link that tracks the current location of the Mobile Node 135 and relays packets to, and in some cases from, the Mobile Node 135. A home agent address (HAA) is a network address of the home agent 145.

The wireless access networks 150 may include multiple wireless access points 155. The construction, arrangement, and functionality of the wireless access networks are conventional and standard. Similarly, the implementation of wireless LAN or similar digital data communication technology in wireless, Mobile Node devices 135 and wireless access points 155 is standard. Detailed description thereof is not necessary to a complete understanding and appreciation of the present invention and is therefore omitted.

To help ensure a secure connection between the Mobile Node 135 and the Home Agents 145, a mechanism for securing telecommunication Binding Update uses Address Based Keys. Address Based Keys use long-standing results in identity based cryptosystems to construct a public key based using the IP address of the Mobile Node 135.

A security association is constructed between the Mobile Node 135 and the Home Agent 145, by using IP security protocol (IPsec) found at ftp://ftp.isi.edu/in-notes/rfc2401.txt. The security association allows cryptographic parameter information to be distributed to the Mobile Node 135 in a confidential and authenticated fashion. The Mobile Node 135, the Home Agent 145, and Correspondent Node 142 implement the identity based cryptosystem. The Home Agent 145 includes an Identity based Private Key Generator (IPKG) or includes secure access to an IPKG.

The Mobile Node 135 is preferably a node which includes an established security association with one or more Home Agents 145 on its home link. The home link includes the subnet in the Mobile Node's home network where the Mobile Node's home address is topologically located. The Mobile Node 135 can detect when it moves between different points of connection in the network 100. The Mobile Node 135 can acquire a temporary care of address in each visited location in the network 100, and signal a current care of address to the Home Agent 145 using the security association. The Correspondent Node 142 includes a node with which the Mobile Node 135 communicates. The Correspondent Node may itself be mobile. The Mobile Node 135 includes a Home Address (HoA) which can include an address of the Mobile Node 135 which does not change as the mobile node moves through the communications network 100. The Home Agent can assign the Home Address (HoA) and send the Home Address (HoA) to the Mobile Node 135.

The Home Agent 145 can be implemented with a router on the home link. The Home Agent 145 can be used to track the Mobile Node's current location and relay packets to, and in some cases from, the Mobile Node 135. To specify the Mobile Node's current location, a Care of address (CoA) IP address can be assigned to the Mobile Node 135. The Mobile Node 135 can perform Route Optimization with the Correspondent Node 142 to avoid routing packets through the Home Agent 145. Performing Route Optimization decreases the latency of communication between the Mobile Node 135 and the Correspondent Node 142. The Mobile Node 135 performs Route Optimization by sending a Binding Update to the Correspondent Node 142 when the care of address is changed. Address Based Keys (ABK) is a technique that allows the Mobile Node 135 and Correspondent Node 142 to verify the authenticity of the Binding Updates.

The Address Based Keys (ABK) encryption technique includes an identity based cryptosystem used to generate the Mobile Node's public key from its Home Address (HoA). Other identity based cryptosystems may be used such that it allows a publicly known identifier, such as the IPv6 address, to be used as the public key for authentication, key agreement, and encryption. The Identity based Private Key Generator (IPKG) includes an agent, such as a computer processor, that can execute an identity based cryptographic algorithm to generate the private key when presented with the public identifier that will act as the public key.

Identity based cryptosystems include cryptographic techniques that allow a publicly known identifier, such as the email address or the IP address of a node, to function as the public key part of a public/private key pair for digital signature calculation, key agreement, and encryption. In identity-based signature protocols, the host, e.g. Mobile Node 135, signs a message using a private key supplied by the IPKG. The signature is then verified using the host's identity. In identity-based encryption, the encryptor uses the recipient's public identity to encrypt a message, and the recipient uses its private key to decrypt the ciphertext. As is generally the case with public key cryptography, the security of the systems depends on the difficulty of solving a hard number theory problem, such as factoring or a discrete log (or Diffie-Hellman) problem. Identity-based cryptosystems can be constructed with or without key escrow. Protocols with key escrow can be performed in fewer passes than corresponding systems that do not provide for key escrow. Techniques from threshold cryptography allow the master key information to be distributed or shared among a number of IPKGs so that all of them can collude for a host's private key to be known to them. Such a scenario would allow for key escrow if necessary, by agreement among all the IPKGs, but guards against knowledge of the private keys by the IPKGs without mutual agreement.

Identity-based cryptosystems include cryptographic systems that allow a publicly known identifier, such as an IPv6 address, to be used as a public key for authentication, key agreement, and encryption. Address Based Keys (ABK) is a cryptographic technique where an identity-based cryptosystem is used to generate the Mobile Node's public key and private key using Public Cryptographic Parameters. Elliptic curve (EC) algorithms are preferred for identity based keys because they work well with small key sizes, are computationally efficient on small hosts, such as small wireless devices, and generate smaller signatures. Other types of algorithms such as non-EC algorithms may also be used such as by using abelian varieties in place of elliptic curves.

Public Cryptographic Parameters include a collection of publicly known parameters, specific to the identity-based cryptographic algorithm, formed from determined constants and a secret master key that is known only to the Identity-based Private Key Generator (IPKG). The IPKG includes an agent that can execute an identity-based cryptographic algorithm to generate a private key when presented with a public identifier that will act as the public key. A preferably public identifier includes the Mobile Node's Home Address (HoA). The IPKG uses a secret master key to generate the private key, and to generate the public cryptoparameters which are distributed to the Mobile Node 135 and Correspondent Nodes 142. The public cryptoparameters are used to perform cryptographic operations between two nodes involved in securing or encrypting a message, such as the Mobile Node 135 and the Correspondent Node 142.

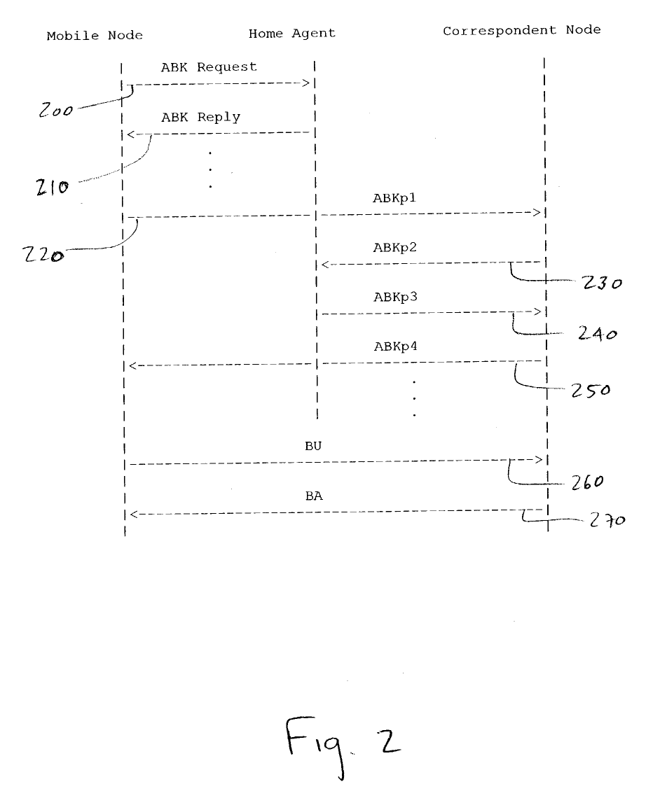

FIG. 2 is a ladder diagram illustrating the use of an Identity-based cryptosystem to secure a Binding Update. At 200, the Mobile Node 135 submits a publicly known identifier to the Home Agent acting as IPKG 145. The publicly known identifier includes the Home Address (HoA) of the Mobile Node 135. The Mobile Node's public key is calculated by applying a hash function specific to the id cryptographic algorithm to the concatenation of the Home Address (HoA) and a determined expiration time, for example one hour. At 210, the IPKG uses an id crypographic algorithm to generate the private key and returns the private key and the expiration time to the Mobile Node 135, encrypted using the IPsec security association. The public and private keys can then be used for authentication and encryption. Identity-based cryptographic algorithms require that a secret known only to the IPKG is used to generate the private key. As a result, unlike the Diffie-Hellman algorithm, the publicly known parameters of the cryptographic algorithm are not fixed, and therefore are not preprogrammed into the Mobile Node 135, Home Agent 145 and Correspondent Node 142. If secret master key expires or becomes compromised, the publicly known parameters are updated.

An identity-based encryption scheme includes an encryption algorithm and a decryption algorithm. Encrypted material, i.e., ciphertext, can be calculated using the following algorithm:

ciphertext=ENCRYPT(contents,IPuK,Params)

where:

ciphertext—The ciphertext.

ENCRYPT—The identity-based encryption algorithm used to encrypt the message contents.

contents—The message contents to be protected.

IPuK—The identity-based public key for the MN.

Params—The public cryptographic parameters of the IPKG.

Note that IPuK =H(ID, time), where

H—A hashing algorithm specific to the identity-based algorithm used for generating the public key from the ID.

ID—The publicly known identifier used to generate the key.

time—Simple Network Time Protocol (SNTP) Version 4 for IPv6 expiration time of the public/private key pair.

The ciphertext can be decrypted using the following, algorithm:

contents=DECRYPT (ciphertext, IPrK, Params)

where:

IPrK—The identity-based private key for the mobile node.

DECRYPT—The identity-based decryption algorithm used to decrypt the ciphertext.

A message authentication code (MAC) can be calculated using the following scheme:

mac=MAC(contents, symK)

where:

mac—the computed authentication token.

MAC—the symmetric-key-based message authentication code algorithm used to compute an authentication token for a message.

contents—the message contents to be authenticated

symK—the symmetric key shared by the sender and recipient of mac.

A IPsec security association is required between the Mobile Node 135 and the Home Agent 145. The IPsec security association is used so that cryptographic parameter information and private key information can be securely distributed to the Mobile Node 135. The Mobile Node 135, Home Agent 145, and Correspondent Node 142 all implement an identity based cryptosystem. The Home Agent 145 performs as the Identity based Private Key Generator (IPKG) or has secure access to an IPKG. Initially, the Mobile Node 135 is configured to have an identity-based public/private key pair that is associated with its 128-bit IPv6 Home Address (HoA), along with the public cryptographic parameters.

At 220, after the configuration phase, the Mobile Node 135 sends a parameter retrieval initiation message to the Correspondent Node 142, such as when the Mobile Node 135 begins a connection with a Correspondent Node 142. At 230 and 240, if the Correspondent Node 142 has not already recorded or cached the associated public cryptographic parameters, the Correspondent Node 142 securely downloads the parameters from Home Agent 145 of the Mobile Node 135. At 250, the Correspondent Node 142 then sends the Mobile Node 135 a shared secret key encrypted with Mobile Node's public key.

At 260, the Mobile Node 135 can then securely send the Binding Update. The Mobile Node 135 can send the secured Binding Update to the Correspondent Node 142 by authenticating the Binding Update with the shared secret session key. The Correspondent Node 142 can verify the authentication token by using the shared secret session key. There is no need to send the public key itself or any certificate. Also, since a symmetric key method is used to authenticate the Binding Update, there is no need to perform potentially slow public key cryptographic operations on each Binding Update. At 270, the Correspondent Node 142 can send a Binding Acknowledgement (BA) to the Mobile Node 135.

The protocol for securely distributing the private key and cryptographic parameters to the Mobile Node 135 includes the following two messages:

1) ABK Request: request private key and parameters

2) ABK Reply: return private key and parameters

The protocol for obtaining the cryptographic parameters from the HA and establishing a shared secret key using ABK includes the following four messages.

1) ABKp1: MN→CN—parameter cache directive

2) ABKp2: CN→HA—request for parameters

3) ABKp3: HA→CN—parameter return

4) ABKp4: CN→MN—parameter cache directive response

ABKp2 and ABKp3 are not necessary if the Correspondent Node 142 has cached the Home Agent 145 parameters.

Standard Mobile IPv6 Binding Update are used:

1) BU: MN→CN—Binding Update+binding authorization data

2) BA: CN→MN—Binding Acknowledgement

These messages are described in more detail below.

The Home Agent 145 can serve as an IPKG for all Mobile Nodes within the domain of the Home Agent 145. The Home Agent 145 generates public cryptographic parameters (Params). The parameters are used with the identity-based cryptographic algorithm. The Mobile Node 135 uses the 128-bit IPv6 Home Address (HoA) assigned to the Mobile Node 135 by the Home Agent 145. The Home Address (HoA) is also used as the basis of the IPsec security association between the Home Agent 135 and the Mobile Node 135 in the base Mobile IPv6 specification.

The Mobile Node 135 then requests the private key IPrK and public cryptographic parameters from the Home Agent 145. The request can be accomplished any time prior to the Binding Update being sent, e.g., through an exchange of messages between the Home Agent 145 and the Mobile Node 135 using the pre-existing IPsec security association. The Home Agent 145 returns IPrK, the parameters, the version number of the parameters, and the SNTP time that the public/private key pair expires. The Mobile Node 135 can compute its public key as IPuK=H(HOA, expiration_time). Message formats are described below for configuring and updating the Mobile Node 135 with its ABK.

The Mobile Node 135 sends an ABKp1 message to the Correspondent Node 142 to cause the Correspondent Node 142 to initiate a request for the public cryptographic parameters. The source address of the packet is the Home Address (HoA) Mobile Node 135. ABKp1 contains a Parameters_version (Params_ver), e.g., a version number of the parameters, and a time SNTP field, e.g., an expiration time of the public/private key pair.

Upon receipt of ABKp1, the Correspondent Node 142 formulates HAA as the Mobile IPv6 Home-Agent anycast address for the subnet prefix of Home Address (HoA) of the Mobile Node 135. The Correspondent Node 142 checks for Params (of the correct version number) and the same expiration time cached for the HAA. If so, the Correspondent Node 142 does not need to send messages ABKp2 and ABKp3 and may send message ABKp4.

If the Correspondent Node 142 does not have Params of the correct version number cached or if the Correspondent Node 142 has an earlier expiration time cached, the Correspondent Node 142 sends an ABKp2 to Home Agent (HA) 145, e.g., using the destination address HAA. This assumes that valid public/private key pairs associated with a particular Home Agent (HA) 145 (PKG) include the same expiration time.

If the Correspondent Node 142 needs to send ABKp2 and ABKp3, ABKp2 contains the following fields:

HoA—the Home Address of the Mobile Node.

Nmac—Home-agent-dependent nonce MAC.

The nonce nmac is:

nmac=MAC(SHA1(HAA, N1), k_{—}CN)

where

N1: nonce

k_CN: a secret key that only the CN knows

The nonce N1 is preferably refreshed periodically, but the same nonce is used for all Home Agents 145 with which the Correspondent Node 142 corresponds during the same time period. The Correspondent Node 142 can also cache recently used nonces.

Upon receipt of ABKp2, the Home Agent 145 determines whether the Home Address (HoA) of the Mobile Node 135 is a known home address. The Home Agent (HA) 145 returns ABKp3 to Correspondent Node 142 with the following fields:

Params.

Params_ver: version number of the parameters

time: SNTP expiration time of the public/private key pair.

AF: Address change authorization flag

nmac.

If the Home Address (HoA) is not a known home address, Params is set to NULL by the Home Agent (HA) 145. If AF is not set, then the Mobile Node 135 can use a globally unique interface identifier. The Correspondent Node 142 determines that the interface identifiers of the Home Address and the care-of address are the same. If AF is set, another method of authorizing the care-of address to change the routing could be used. Upon receipt of ABKp3, the Correspondent Node 142 checks Params and computes MAC(SHA1(HAA, N1), k_CN). If Params is set to NULL or if nmac does not match the computed MAC value then authenticatoin fails. The Correspondent Node 142 does not send an error message. If Params is not NULL, the Correspondent Node 142 caches HAA (source address of message ABKp3), the parameters, the version number of the parameters, the current key expiration time, and the address change authorization flag.

ABKp4 contains the following field:

E=ENCRYPT(k_{—}m, IPuK, Params)

where

k_{—}m=SHA1(HoA, k_{—}CN).

k_m is a secret key that the Correspondent Node 142 generates and shares with the Mobile Node 135. The key is encrypted with the public key IPuK of the Mobile Node 135, which may be derived from the Home Address (HoA) of the Mobile Node 135 and the public/private key expiration time. When the Mobile Node 135 receives ABKp4, it computes k_m 32 DECRYPT(E, IPrK, Params) to use in computing the Binding Update.

A Binding Update message can be sent from the Mobile Node 135 to the Correspondent Node 142 according to standard Mobile IPv6 procedures. In addition to the standard fields, the Binding Update contains a Binding Authorization Data option, which contains a MAC calculated over the following fields:

The BU contents (including HoA).

k_r—random value generated by the Mobile Node.

The Authenticator calculated as follows:

mac=MAC(SHA1(BU, k_{—}r), k)

where the session key can be computed as k=SHA1(k_m|k_r).

Upon receiving the Binding Update, if the address change authorization flag AF is not set for the Home Address (HoA) of the Mobile Node 135, the Correspondent Node 142 determines whether the interface identifier on the proposed Care of Address (CoA) matches the interface identifier on the Home Address (HoA) in the Home Address Option of the Binding Update packet. If the interface identifier does not, the Correspondent Node 142 sends a Binding Acknowledgment (BA) with the appropriate error code.

If AF is set, then the Binding Update begins an address change authorization algorithm to determine whether the Mobile Node 135 can change the address.

If AF is not set and the interface identifier on the proposed Care of Address (CoA) matches that of the Home Address (HoA) in the Home Address Option of the Binding Update packet or if the AF is set and the address change is authorized, the Correspondent Node 142 computes k_m=SHA1(HoA, k_CN) and then computes k=SHA1(k_m|k_r). The Correspondent Node 142 then verifies the Binding Update by comparing the value mac from the Authenticator in the Binding Authorization Data option to MAC(SHA1(BU, k_r), k). If the two values match, the Correspondent Node 142 sends a Binding Acknowledgment (BA) message that indicates success; otherwise, the Correspondent Node 142 sends a Binding Acknowledgment (BA) message that indicates failure.

The Mobile Node 135 uses the same interface identifier for its Care of Address (CoA) as in the Home Address (HoA), unless the Home Agent (HA) 145 has indicated otherwise in ABKp3 by setting the,Address Change Authorization flag. If the flag is not set and a different interface identifier appears in the binding update, the Correspondent Node 142 rejects the Binding Update and sends an error Binding Acknowledgment (BA) to the Mobile Node 135 that indicates that the Binding Update is rejected.

The Mobile Node 135 may use a different interface identifier for the Care of Address (CoA) if the Home Agent 145 has indicated by setting the Address Change Authorization flag that some procedure is in place. The different interface identifier allows the Correspondent Node 142 and Mobile Node 135 to agree on a way of authorizing that a Mobile Node 135 with a particular Home Address (HoA) is allowed to change to a particular Care of Address (CoA). Cryptographically generated addresses and AAA are examples of such procedures.

The Mobile Node/Home Address (HoA) association can be verified. The Correspondent Node 142 receives parameters directly from the Home Agent (HA) 145. Also, only the true Mobile Node 135 can decrypt the shared secret key, which is used to generate the session keys that authenticate the Binding Updates.

If a Mobile Node 135 attempts to flood a Correspondent Node 142 with ABKp1 messages, for each message, the Correspondent Node 142 checks a parameters table to determine if the Correspondent Node 142 has the parameters for the relevant Home Agent 145. If not, the Correspondent Node 142 sends an ABKp2 message to the Home Agent 145 to request parameters. The Correspondent Node 142 will not send an ABKp2 message to the same Home Agent 145 more than once unless the parameters have expired. The Correspondent Node 142 does not create state. If a Home Agent 145 is flooded with ABKp2 messages, the Home Agent 145 discards all messages that include a Home Address (HoA) that is not in the domain of the Home Agent 145.

The nonce MAC nmac is used to prevent attackers who might attempt to initiate communications with the Correspondent Node 142, or flood the Correspondent Node 142 by using message ABKp3. For a flood of ABKp4 messages, the Mobile Node 135 ignores any messages if the Mobile Node 135 did not initiate an ABKp1 message. The Correspondent Node ignores Binding Update messages whose MACs cannot be verified. The Mobile Node 135 ignores Binding Acknowledgment (BA) messages from nodes with which Mobile Node 135 did not initiate a Binding Update.

If an attacker on one path between any two entities (Mobile Node 135, Correspondent Node 142, Home Agent 145) can alter messages, at worst the Binding Update would fail. The Correspondent Node 142 could continue to send Mobile Node packets to an old Care of Address (CoA). Since messages ABKp1 through ABKp3 are not signed, a possibility exists to change them. However, if message ABKp4 is encrypted in a way that ABKp4 can also be authenticated, ABKp4 cannot be changed. The Binding Update is accomplished with MAC, so that the Binding Update is not susceptible to a data alteration attack.

Alternatively, if the Correspondent Node 142 includes a standard public key certificate for the Home Agent 145, the Correspondent Node 142 can use another protocol, such as a TLS (Transport Level Security, RFC 2246) protocol to transact ABKp2 through ABKp3. The TLS protocol can prevent an attack on the Home Agent transaction.

A redirect attack can occur if the Mobile Node 135 can send the Correspondent Node 142 a Binding Update containing an false Care of Address (CoA) in a different subnet that corresponds to the victim. The Correspondent Node 142 will then redirect the Mobile Node's traffic to the victim, even though the victim has no interest in the traffic. Redirect attacks can be prevented by requiring that the Mobile Node 135 use an interface identifier assigned to it by the Home Agent 145 in the Home Address (HoA) of the Mobile Node 135 to also form the Care of Address (CoA). This prevents the Mobile Node 135 from forming a Care of Address (CoA) that corresponds to any node other than itself. The Mobile Node 134 uses the same interface identifier in every Care of Address (CoA). Use of the same identifier does not limit route optimization because route optimized packets contain a Home Address Option containing the home address anyway.

An ABK distribution protocol provides the Mobile Node 135 with an ABK from the Home Agent 145 initially and periodically if necessary when the key expires or if the parameters change. The protocol uses TCP (Transmission Control Protocol) transport to a port to be assigned, for example, by IANA. The protocol can be secured using IPsec ESP and the Home Agent/Mobile Node security association defined by the base Mobile IPv6 specification. The protocol contains two messages, an ABK Request and an ABK Reply.

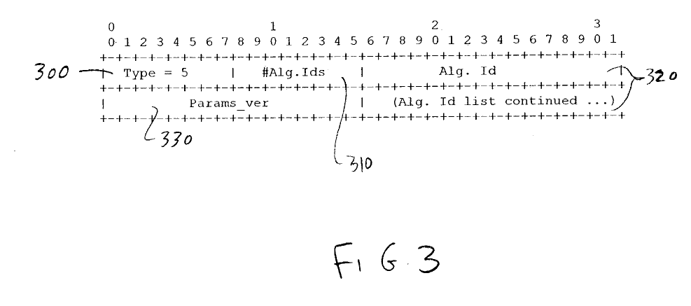

FIG. 3 illustrates an ABK Request message. The ABK Request message is sent by the Mobile Node 135 to the Home Agent 145 to request a new ABK. The source address is the Mobile Node home address. The destination address is the Home Agent address. An IPsec Header such as an ESP IPsec header for the Home Agent/Mobile Node security association can be included, and the packet can be encrypted using the shared key. The ABK message type code 300 is set to an identifier, such as 5. The #Alg. Ids 310 is the number of four byte algorithm identifier records to follow, which is not zero. For each record, the Alg. Id 320 includes a two byte identity-based cryptographic algorithm identifier, assigned by IANA. Params_ver 330 includes a two byte parameter version number for the algorithm identifier.

If the Mobile Node 135 is not on the home network, the Mobile Node 135 establishes a valid binding between the Care of Address (CoA) and Home Address (HoA) before sending this message and reverse tunnel the message to the Home Agent 145 to avoid ingress filtering on the foreign subnet. The Mobile Node 135 includes a list of identity-based cryptographic algorithm identifiers indicating the algorithms that the Mobile Node 135 supports, and the version numbers for the latest version of the parameters known to the Mobile Node 135. The list may be in order of the Mobile Node preferences, for example, with the most preferred algorithm first.

The IPsec security association assures that only Mobile Nodes 135 with valid, assigned Home Addresses (HoAs) can communicate with the Home Agent 145. Upon receipt of an ABK Request, for each algorithm in the list in which the parameter version is not equal to the most current version, the Home Agent 145 calculates IPrK. First, the Home Agent 145 calculates IPuK using the source address of the packet, e.g., the Home Address (HoA) as the public identifier, and an SNTP expiration time for the key. Next, the Home Agent 145 uses IPuK, the parameters, and the algorithm to calculate IPrK. The results are returned to the Mobile Node 134 in the ABK Reply message.

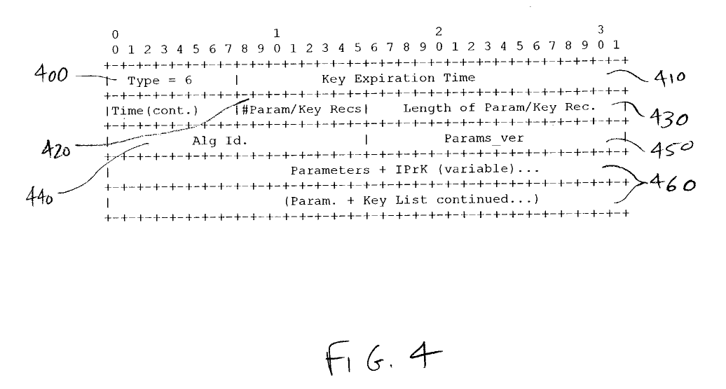

FIG. 4 illustrates an ABK Reply message. The ABK Reply message contains a list of parameters for the algorithms requested by the Mobile Node 135 and supported by the Home Agent 145. An expiration time value also is included, which the Mobile Node 135 used to compute the public key. Regarding the IP fields, the Source Address is the Home Agent address. The Destination Address is the Home Address (HoA) of the Mobile Node. Regarding IP Headers, the ESP IPsec header for the Home Agent/Mobile Node security association is included, and the packet is encrypted using the shared key.

Regarding the Message Fields, the ABK message type code 400 is set to a number, such as 6, that differentiates the message from other messages. The Key Expiration Time 410 includes a four byte positive integer giving the time that the key expires. The #Param/Key Recs 420 includes the number of per algorithm variable length records including parameters and keys to follow. For each record, the Length of Param/Key Rec. 430 is the Length, in bytes, of the parameter record to follow, including the Alg. Id. 440, Params_ver 450, and Parameters+IPrK list 460. The Alg. Id 440 is a two byte identity-based cryptographic algorithm identifier, assigned by IANA. The Params_ver 450 is a two byte parameter version number for the algorithm identifier. The Parameters+IPrK 460 is a variable length parameters+IPrK list, the format of which is specified by the algorithm identifier specification.

The Home Agent 145 returns an ABK Reply message in response to an ABK Request, encrypted and with the proper ESP security header. The ABK Reply message can be tunneled to the Mobile Node 135 at its CoA if the Mobile Node 1353 is not in a home network, just as with other traffic routed through the Home Address (HoA) of the Mobile Node 135. If the Home Agent 145 does not support any of the algorithms requested by the Mobile Node 135, the Key Expiration time 410 and #Param Recs 420 fields are zero. Otherwise, these fields are other than zero. If the Home Agent 145 does not support a particular algorithm, a record can be included with the indicated algorithm's Alg. Id 440. If the algorithm is not supported, the Params_ver 450 field is zero and no Parameters+IPrK field 460 is used.

If the parameter version in the ABK Request for a particular algorithm supported by the Mobile Node 135 is current, a record can be included with the indicated algorithm's Alg. Id 440 and the current Params_ver 450, but no Parameters+IPrK field 460 is needed. The Mobile Node 135 can continue to use cached parameters and IPrK until the parameters change or its key expires. The IPsec security association assures that the Home Agent 145 can send the Mobile Node 135 an ABK Reply. Upon receipt of the ABK Reply, the Mobile Node caches the IPrKs and parameters for each algorithm, for use in securing Binding Updates. When the keys expire, the Mobile Node 135 requests a new private key IPrK for the identity-based cryptographic algorithms that the Mobile Node 135 supports.

During the parameter initialization phase, the Mobile Node 135 requests that the Correspondent Node 142 initialize the parameters from the Home Agent 145. The Mobile Node 135 operates the parameter initialization protocol when the Mobile Node 135 changes IPrK and parameters. The protocol uses TCP over the IANA TBD assigned port as used for the ABK distribution protocol. The Mobile Node 135 can reverse tunnel ABKp1 through the Home Agent 145 to the Correspondent Node 142, if not located on the home network, to initiate the protocol. ABKp4 can be tunneled through the Home Agent 145 to the Mobile Node 142 by standard Mobile IP mechanisms. ABKp2 and ABKp3 are exchanged between the Correspondent Node 142 and Home Agent 145.

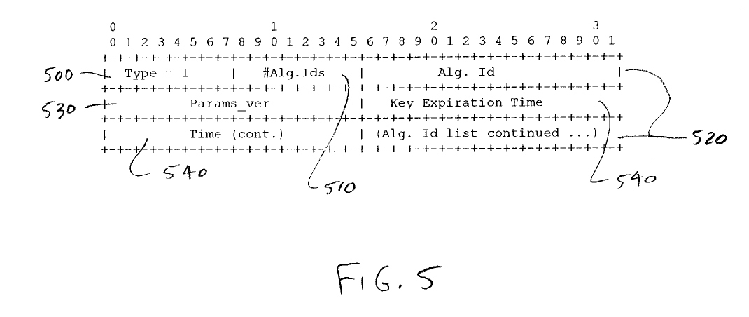

FIG. 5 illustrates an ABKp1 message. ABKp1 is reverse tunneled from Mobile Node 135 through the Home Agent 145, if the Mobile Node 135 is not located on the home network, to the Correspondent Node 142 to being the protocol for securing a Binding Update. The source address is the Home Address of the Mobile Node 135. The destination address is the address of the Correspondent Node 142. The ABK message type code 500 is set to a number to differentiate from other messages, such as 1. The #Alg. Ids 510 is the number of four byte algorithm identifier records 520 to follow, greater than zero. For each record, the Alg. Id 520 is a two byte identity-based cryptographic algorithm identifier, assigned by IANA. The Params_ver 530 is a two byte parameter version number for the algorithm identifier. The parameter version number identifies the version of the parameters currently held by the Mobile Node 135. The Key Expiration Time 540 is a four-byte SNTP time which identifies the expiration time of the Mobile Node's key.

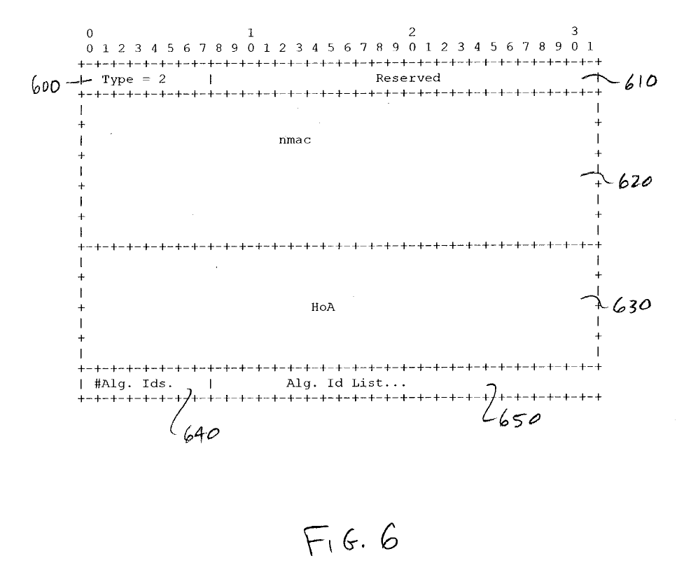

FIG. 6 illustrates an ABKp2 message. ABKp2 is sent by the Correspondent Node 142 to the Home Agent 145. The source address is the address of the Correspondent Node 142. The destination address is the Home Agent anycast address located in the Mobile Node's subnet, determined by the Home Address (HoA) subnet prefix of the Mobile Node 135. The Message Fields include a Type field 600. The ABK message type code is set to a number different from other messages, such as 2. The Reserved field 610 is set to zero upon transmission and ignored on reception. The nmac field 620 identifies nonce MAC, a 160 bit HMAC SHA-1 value. The HoA field 630 identifies the Home Address of the Mobile Node 135. The #Alg. Ids field 640 identifies the number of two byte algorithm identifier records to follow, which is not zero. For each record, Alg. Id 650 identifies a two byte identity-based cryptographic algorithm, assigned by IANA or another entity.

The algorithm id list identifies the algorithms supported by the Correspondent Node 142 that were included in the list sent by the Mobile Node 135 in ABKp1, for which the version number of the parameters cached by the Correspondent Node 142 does not match that sent by the Mobile Node 135. The Correspondent Node 142 does not send ABKp2 if the Correspondent Node 142 has a set of cached parameters with a version number matching at least one of the algorithms on the list sent by the Mobile Node 135 in ABKp1. The Correspondent Node 142 uses the matching algorithm.

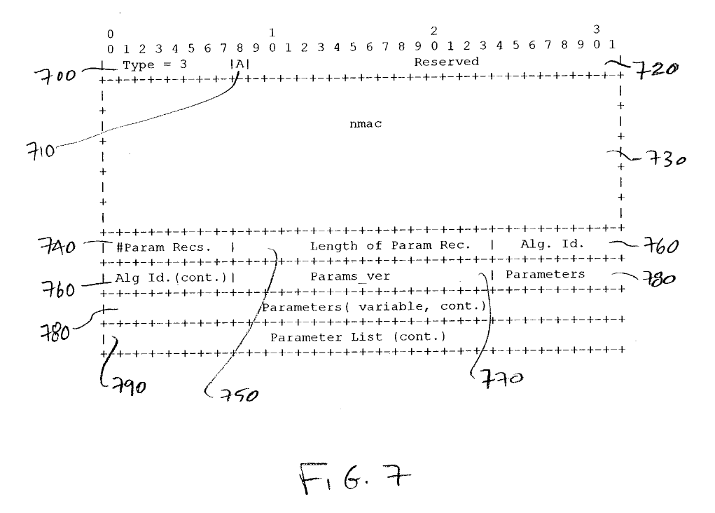

FIG. 7 illustrates an ABKp3 message. The source address is the address of the Home Agent 145. The destination address is the address of the Correspondent Node 142. The Message Fields include a Type field 700. The ABK message type code is set to a unique message number, such as 3. The A field identifies an Unset and Set command. The Unset command is used if the Home Agent 145 requires the Mobile Node 135 to use the same interface identifier for CoAs as for the Home Address (HoA). The Set command is used if a different address change authorization procedure is used. The Reserved field 720 is set to zero upon transmission. The nmac field 730 identifies nonce MAC, a 160 bit HMAC SHA-1 value that matches the nonce value sent in ABKp2.

The #Param Recs 740 identifies the number of variable length parameter records to follow. For each record, the Length of Param Rec field 750 identifies the length, e.g., in bytes, of the parameter record to follow, including the Alg. Id. 760, the Params_ver 770, and the Parameters 780. The Alg. Id field 760 includes a two byte identity-based cryptographic algorithm identifier, e.g., assigned by IANA. The Params_ver field 770 includes a two byte parameter version number for the algorithm identifier. The Parameters field 780 includes a variable length parameters list 790, the format of which can be determined by the algorithm identifier specification.

If the Home Agent 145 has no record of the Home Address (HoA) of the Mobile Node 135, the Home Agent 145 returns ABKp3 with the #Param Recs. field 740 set to zero. Otherwise, #Param Recs. field 740 is not set to zero. If the Home Agent 145 does not support one of the algorithms on the list sent in ABKp3, the Home Agent 145 sends a record with the indicated algorithm's identifier in the Alg. Id field 760, the Params_ver field 770 is set to zero and no parameters exist in the Parameters field 780. Otherwise, the Home Agent 145 includes a parameter record for each algorithm included in ABKp2 for which the Home Agent 145 has parameters.

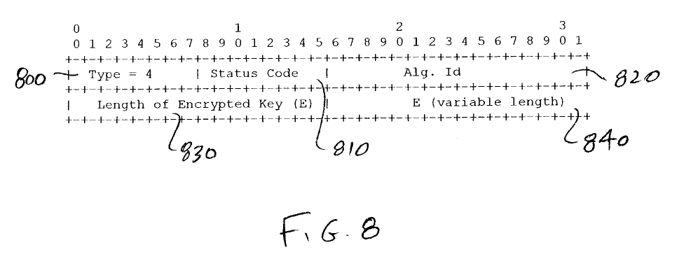

FIG. 8 illustrates an ABKp4 message. Regarding the IP Fields, the Source Address is the Correspondent Node's address. The Destination Address is the home address of the Mobile Node. The Message Fields include the Type field 800. The ABK message Type field 800 code is set to a unique message number, such as 4. A Status Code field 810 includes a code indicating a message status. Exemplary recognized codes follow:

0—Status OK.

1—No algorithm supported. A ‘1’ code is returned if the Mobile Node 135 and the Correspondent Node 142 do not share an algorithm in common.

2—Parameters out of date. A ‘2’ code is returned if the version numbers of the parameters returned by the Home Agent 142 for all algorithms shared with the MN are newer than the version numbers provided by the Mobile Node 135.

The Alg. Id field 820 is a two byte algorithm identifier for the algorithm to be used by the Correspondent Node 142 to encrypt the Session Key. The Length of Encrypted Key field 830 identifies the length, in bytes, of the encrypted session key (E). As described above, E can equal ENCRYPT(k_m, IPuK, Params). The Encrypted Session Key (E) is contained in the ‘E’ field 840.

The algorithm identifier specification contains the format of the shared key and other data. The Correspondent Node 142 selects an algorithm from the list sent by the Mobile Node 135 in ABKp1 for which parameters are available as returned by the Home Agent 145 in ABKp3, or cached by the Correspondent Node 142 if no ABKp2/ABKp3 message was necessary. The Correspondent Node 142 includes the selected algorithm's identifier in the Alg. Id field 820. The Correspondent Node 142 can select the algorithm closest to the beginning of the list sent by the Mobile Node 142 in ABKp1, since the list is sorted by order of Mobile Node preference.

The Encrypted Session Key field 840 contains the session key, encrypted using the public key (calculated from the home address (HoA) of the Mobile Node 135 and the key expiration time) and the algorithm parameters. The format of this field depends on the algorithm and is included in the algorithm specification. The Correspondent Node 142 does not send a return message if the Home Agent 145 indicates that the Home Agent 145 does not recognize the Mobile Node's Home Address (HoA).

If the Correspondent Node 142 is able to select an algorithm with parameters on which the Correspondent Node 142 and Mobile Node 135 agree, the Status Code field 810 is set to zero and the remainder of the message is filled. If the Status Code field is not zero, the Correspondent Node 142 does not include any other fields. If the Correspondent Node 142 and Mobile Node 135 can agree on at least one algorithm and the parameter versions match, the Correspondent Node 142 selects that algorithm. The Correspondent Node 142 does not send a nonzero status code unless there are no matching choices.

A Mobile Node 135 using ABK to secure Binding Updates includes a standard Mobile IPv6 Binding Authorization Data extension, with the authentication token _mac_, calculated as described above, in the Authenticator field. The Correspondent Node 142 verifies the Authenticator, as described above. If the Authenticator fails to be verified, the Correspondent Node 142 returns a Binding Acknowledgement (BA) with error code 137, Invalid authenticator. If the address change authorization check fails, an error code is sent that the Mobile Node 135 is not authorized for that CoA.

For an identity-based encryption algorithm to be used in ABK Binding Updates, a specification exists to describe the algorithm and provide, an IANA assigned algorithm type code, a format of the Parameters+IPrK field in the ABK Reply message, a format of the Parameters field in ABKp3, and a format of E in ABKp4. The specification is established by IETF standards action. A TCP socket number is determined for the protocol, to be assigned by IANA. A Mobile IP Binding Acknowledgement error code may be determined for when the Mobile Node 135 is not authorized to change to a particular Care of Address CoA.

While the invention has been described above by reference to various embodiments, it will be understood that many changes and modifications can be made without departing from the scope of the invention. It is therefore intended that the foregoing detailed description be understood as an illustration of the presently preferred embodiments of the invention, and not as a definition of the invention. It is only the following claims, including all equivalents, which are intended to define the scope of this invention.

1. A method of securing binding updates in a wireless telecommunications system, the method comprising:
generating a public key using a publicly known identifier;
generating a private key using the public key; and
utilizing the public key and the private key to secure binding updates.

2. The method of claim 1 wherein a home agent generates the public key.

3. The method of claim 1 wherein a home agent generates the private key.

4. The method of claim 3 wherein the home agent provides the private key to the mobile host.

5. The method of claim 4 further including a correspondent node connectable with a mobile host, wherein the public key, a shared key and a public parameter are used to secure binding updates between the mobile host and the correspondent node.

6. The method of claim 5 wherein the correspondent node encrypts the shared key with the public key and the public parameter.

7. The method of claim 5 wherein the mobile host uses the shared key to sign the binding update and sends a signed binding update to the correspondent node.

8. The method of claim 5 wherein the home agent provides the public parameters to the correspondent node.

9. The method of claim 1 wherein the public key is generated using a home address value of the mobile host.

10. A system for securing binding updates in a wireless telecommunications system, comprising:
a mobile host connectable to the telecommunications system;
a correspondent node connectable with the mobile host, wherein a public key and a private key are used to secure binding updates between the mobile host and the correspondent node.

11. The system of claim 10 further including a home agent connectable with the mobile host and correspondent node.

12. The system of claim 11 wherein the home agent generates the private key and a public parameter.

13. The system of claim 10 wherein the public key is generated using a home address value of the mobile host.

14. The system of claim 11 wherein the home agent generates the private key.

15. The system of claim 11 wherein the home agent provides the private key and public parameters to the mobile host.

16. The system of claim 15 wherein a correspondent node encrypts a shared key with the public key and public parameters.

17. The system of claim 16 wherein the mobile host uses the shared key to sign the binding update and sends a signed binding update to the correspondent node.

18. The system of claim 16 wherein the mobile host provides the public parameters to the correspondent node.

19. A mobile node for use in a wireless telecommunications system, comprising:
an interface capable of connecting the mobile node to a home agent and a corresponding node, wherein a public key and a private key are used to secure binding updates between the mobile node and the correspondent node.

20. The mobile node of claim 19 wherein the home agent generates the private key and a public parameter.

21. The mobile node of claim 19 wherein the public key is generated using a home address value of the mobile node.

22. The mobile node of claim 19 wherein the home agent generates the private key.

23. The mobile node of claim 19 wherein the home agent provides the private key and public parameters to the mobile node.

24. The mobile node of claim 23 wherein the correspondent node encrypts a shared key with the public key and public parameters.

25. The mobile node of claim 24 wherein the mobile node uses the shared key to sign the binding update and sends a signed binding update to the correspondent node.

26. The mobile node of claim 24 wherein the interface is used to provide the public parameters to the correspondent node.
